(19) United States
(12) Patent Application Publication
(10) Pub. No.: US 2021/0278537 A1
(43) Pub. Date: Sep. 9, 2021

(54) LASER TRANSMITTING AND RECEIVING MODULE FOR LIDAR

(71) Applicants: HYUNDAI MOTOR COMPANY, Seoul (KR); KIA MOTORS CORPORATION, Seoul (KR); KOREA ADVANCED INSTITUTE OF SCIENCE AND TECHNOLOGY, Daejeon (KR)

(72) Inventors: Chan-Hee Kang, Hwaseong-si (KR); Kyeong-Jin Han, Daejeon (KR); Geum-Bong Kang, Daejeon (KR); Hyo-Hoon Park, Daejeon (KR); Seong-Hwan Kim, Daejeon (KR)

(21) Appl. No.: 16/899,959

(22) Filed: Jun. 12, 2020

(30) Foreign Application Priority Data
Mar. 5, 2020 (KR) 10-2020-0027790

(51) Int. Cl. G01S 17/34; G01S 7/481; G01S 7/4915

(52) U.S. Cl. CPC G01S 17/34; G01S 7/4816; G01S 7/4915; G01S 7/4811; G01S 7/4814

(57) ABSTRACT

A laser transmitting and receiving module for a light detection and ranging (LiDAR) may include a laser light source; a transmission optical phased array (OPA) device configured to emit laser light from the laser light source into a two-dimensional (2D) area; a reception OPA device configured to receive reflected laser light after being emitted by the transmission OPA device; a mixer configured to mix the laser light with the reflected laser light received by the reception OPA device; and a photo detector configured to detect an optical signal mixed by the mixer.

### CROSS-REFERENCE(S) TO RELATED APPLICATIONS

The present application claims the benefit of priority to Korean Patent Application No. 10-2020-0027790, filed on Mar. 5, 2020 with the Korean Intellectual Property Office, which is incorporated herein by reference in its entirety.

### TECHNICAL FIELD

Exemplary embodiments of the present disclosure relate to a laser transmitting and receiving module for a light detection and ranging (LiDAR) system for autonomous driving.

### BACKGROUND

The term “LiDAR” is an abbreviation of light detection and ranging and is a device for emitting a laser pulse, receiving the laser pulse reflected from a surrounding target object, and measuring a distance to the target object to accurately reproduce the surroundings of a vehicle. A typical LiDAR system includes a controller, a transmission module, a reception module, and an optical module for beam steering.

The optical module for beam steering employs a motor rotating mirror optical system, and required quality in long-term durability of a mechanical optical system may not be robust to long-term durability of a vehicle.

In order to improve such a motor rotating mirror scanning method, an optical phased array (OPA) technology is recently developed.

The OPA technology is a semiconductor type optical device technology which electrically control a refractive index (a phase of light) of a silicon material, through which the light is guided, to adjust a direction of the light. That is, a plurality of small paths (waveguides) through which lights can pass using a silicon semiconductor process are formed and serve as an optical module for beam steering by electrically and individually modulating phases of the lights passing through the small paths to allow a beam to have directivity according to controlled phases of the lights in an output part.

An OPA driving method includes various methods such as a time of flight (ToF) method, a frequency modulated continuous wave (FMCW) method, and the like according to the nature of input light, and different transmission and reception module structures are required according to an operating method. Recently, an operating method attracting attention is the FMCW method. The FMCW method has a longer sensing distance and excellent resolution as compared to the ToF method but has a disadvantage of requiring complicated transmission and reception modules.

The information disclosed in the Background section above is to aid in the understanding of the background of the present disclosure, and should not be taken as acknowledgement that this information forms any part of prior art.

### SUMMARY

An exemplary embodiment of the present disclosure is directed to a core optical device for a next-generation autonomous vehicle, which is capable of achieving innovative miniaturization and performance improvement (detection of a long-distance object) of light detection and ranging (LiDAR) components by integrating an optical phased array (OPA) system circuit for distance measurement in a frequency modulated continuous wave (FMCW) method using a semiconductor process.

Other objects and advantages of the present disclosure can be understood by the following description and become apparent with reference to exemplary embodiments of the present disclosure. Also, it is obvious to those skilled in the art to which the present disclosure pertains that the objects and advantages of the present disclosure can be realized by the means as claimed and combinations thereof.

In accordance with an exemplary embodiment of the present disclosure, a laser transmitting and receiving module for light detection and ranging (LiDAR) may include a laser light source, a transmission optical phased array (OPA) device configured to emit laser light from the laser light source into a two-dimensional (2D) area, a reception OPA device configured to receive reflected light after being emitted by the transmission OPA device, a mixer configured to mix the laser light with the reflected light received by the reception OPA device, and a photo detector configured to detect an optical signal mixed by the mixer.

Further, the laser transmitting and receiving module may further include a variable optical attenuator arranged at a front stage of the transmission OPA device and configured to equally adjust optical power, and a directional coupler arranged at a front stage of the variable optical attenuator and configured to allow a portion of the laser light to branch off to the mixer.

Further, the directional coupler may allow the portion of the laser light traveling to the variable optical attenuator to branch off to the mixer as reference light, the mixer may mix the reference light with the reflected light, and the photo detector may detect an optical signal undergoing down-conversion and obtaining a conversion gain.

Further, the directional coupler, the photo detector, and the mixer may serve as a reception module required in a frequency modulated continuous wave (FMCW) operating method.

Meanwhile, the laser transmitting and receiving module may further include a mixer arranged at a front stage of the photo detector and configured to receive the reference light and the reflected laser light and convert and mix a phase.

Here, the photo detector may include a traveling-waveguide type photo detector (PD) having a silicon p-n junction structure.

More specifically, the transmission OPA device may include a power splitter configured to allow the laser light to branch off into N channels, ‘N’ is a natural number of two or more, a phase shifter configured to control each of phases of the laser light incident on the N channels, and a radiator configured to radiate the laser light phase-controlled by the phase shifter to a free space with a specific directionality.

Further, the power splitter may include a multimode interference (MMI) power splitter.

Further, the phase shifter may control the phase of the laser light reaching the radiator to control the laser light radiated through the radiator toward a specific direction.

Here, the phase shifter may control the phase by an electro-optic method (a p-i-n or p-n structure) or a thermo-optic method (a p-i-n or external metal heater structure).

Further, the radiator may be formed to be disposed as a 1×N radiator array.

Further, each radiator of the 1×N radiator array may be formed in any one structure among a lattice structure, a mirror structure, or a nano-metal thin film structure.

Further, a plurality of radiators may be formed to be disposed as a 1×N radiator array in a longitudinal direction.

Further, the transmission OPA device may be disposed as a plurality of transmission OPA devices in parallel, and a switch configured to sequentially operate the plurality of transmission OPA devices may be arranged at a rear stage of the variable optical attenuator.

Next, the reception OPA device may include a receiver configured to receive the reflected laser light through the N channels, a phase shifter configured to control each of phases of the reflected laser light branching off in the N channels, and a power combiner configured to combine the reflected laser light which is phase-controlled and received through the N channels.

Further, the phase shifter of the reception OPA device may control phases of the reflected laser light received through the N channels in the same manner as in the phase control by the transmission OPA device.

Here, the reception OPA device may be disposed as a plurality of reception OPA devices in parallel, and a switch configured to sequentially operate the plurality of reception OPA devices may be arranged at a rear stage of the power combiner.

In accordance with another exemplary embodiment of the present disclosure, a laser transmitting and receiving module for light detection and ranging (LiDAR) may include a transmission optical phased array (OPA) device configured to transmit laser light from a laser light source to a two-dimensional (2D) area, and a reception OPA device configured to receive reflected laser light after being transmitted by the transmission OPA device, wherein the transmission OPA device and the reception OPA device are modularized as a single silicon-based semiconductor device.

Further, the transmission OPA device may include a power splitter configured to allow the laser light to branch off into N channels, ‘N’ is a natural number of two or more, a phase shifter configured to control each of phases of the laser light incident on the N channels, and a radiator configured to radiate the laser light phase-controlled by the phase shifter with a specific directionality.

Further, the reception OPA device may include a receiver configured to receive the reflected laser light through the N channels, a phase shifter configured to control each of phases of the reflected laser light received through the N channels, and a power combiner configured to combine the reflected laser light which is phase-controlled and received through the N channels.

Further, the laser transmitting and receiving module may further include a photo detector configured to compare the laser light with the reflected laser light received by the reception OPA device, and a mixer arranged at a front stage of the photo detector and configured to receive the reference light and the reflected laser light and to convert and mix a phase.

### BRIEF DESCRIPTION OF THE DRAWINGS

FIG. 1 is a diagram illustrating a laser transmission and reception module for light detection and ranging (LiDAR) according to an exemplary embodiment of the present disclosure.

FIG. 2 is a conceptual diagram illustrating a processing of a beam due to the laser transmission and reception module for LiDAR according to an exemplary embodiment of the present disclosure.

FIG. 3 is a schematic diagram illustrating light received by a reception optical phased array (OPA) device 130 according to an exemplary embodiment of the present disclosure.

### DESCRIPTION OF SPECIFIC EMBODIMENTS

Reference should be made to the accompanying drawings that illustrate exemplary embodiments of the present disclosure, and to the description in the accompanying drawings in order to fully understand the present disclosure and operational advantages of the present disclosure, and objects attained by practicing the present disclosure.

In the description of exemplary embodiments of the present disclosure, known technologies or repetitive descriptions which unnecessarily obscure the gist of the present disclosure may be reduced or omitted.

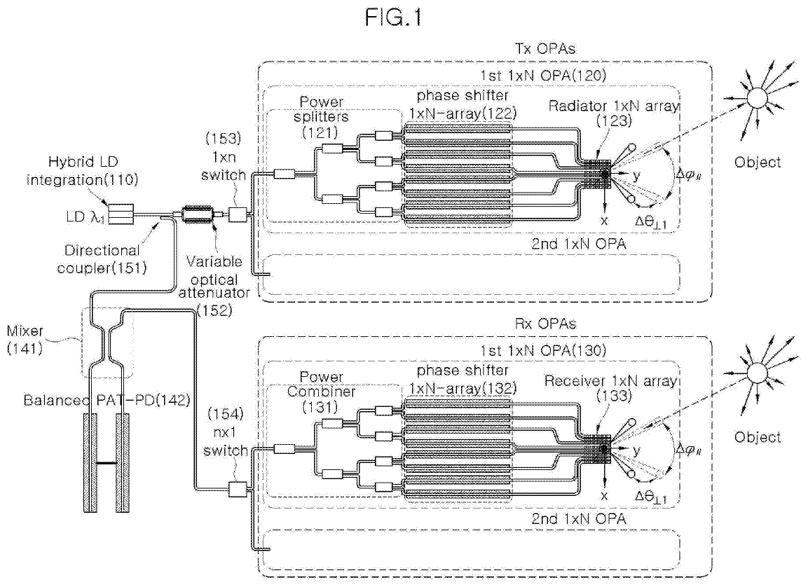

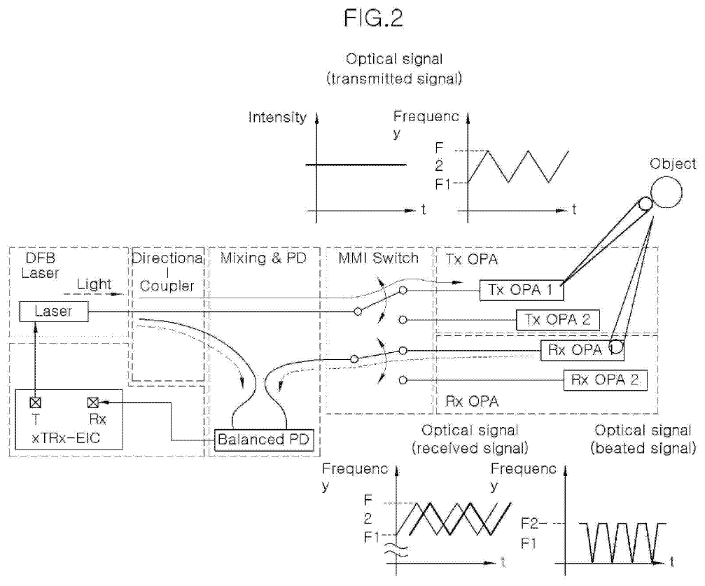

FIG. 1 is a diagram illustrating a laser transmission and reception module for light detection and ranging (LiDAR) according to an exemplary embodiment of the present disclosure, and FIG. 2 is a conceptual diagram illustrating a processing of a beam due to the laser transmission and reception module for LiDAR according to an exemplary embodiment of the present disclosure. Hereinafter, a laser transmission and reception module for LiDAR according to one exemplary embodiment of the present disclosure will be described with reference to FIGS. 1 and 2.

The present disclosure relates to the laser transmission and reception module for a LiDAR system, which measures a distance using a beam from a laser light source 110 through a transmission optical phase array (OPA) device 120 and a reception OPA device 130 in a frequency modulated continuous wave (FMCW) method.

For example, the laser light source 110 (hybrid laser diode (LD) integration) serves to emit a laser having a wavelength of 1,550 nm, and light of the emitted laser travels to a variable optical attenuator 152. The variable optical attenuator 152 equalizes optical power incident on the transmission OPA device 120.

In the process of changing a frequency of light using laser chirping, an unintended variation in optical power output of an LD may occur. Since the unintended variation may affect a stable operation of the transmission OPA device 120, a device is required for equalizing optical power entering the transmission OPA device 120 in real time using the variable optical attenuator 152.

In the present disclosure, the variable optical attenuator 152 may be employed as the above device to equalize the optical power, and a variable optical attenuator based on a Mach-Zehnder interferometer having, e.g., a silicon p-n junction, a p-i-n junction, or a metal heater structure as an arm of each phase shifter may be applied. Since the above technology is applied, the optical power incident on the transmission OPA device 120 is equalized to allow the transmission OPA device 120 to perform a stable operation.

Further, a directional coupler 151 is disposed on a path so that a reference light travels to a photo detector 142 (balanced photon assisted tunneling (PAT)-PD) separately from the laser traveling to the variable optical attenuator 152.

Hybrid integration of semiconductor-based LDs may be achieved by various methods including a method using an inverse taper structure of various materials, a method using a fiber block array, a method using a micro-mirror of a parabolic concave shape, and the like.

A portion of light emitted through the LDs travels to the transmission OPA device 120 via the variable optical attenuator 152, the remaining portion of the light is separated through the directional coupler 151 located at a front stage of the variable optical attenuator 152 to travel to the photo detector 142 via a mixer 141, and a ratio of an amount of the divided light is determined according to a design parameter of the directional coupler 151.

Further, a current should be supplied so as to drive a semiconductor LD. A variation in central wavelength of the laser occurs according to a variation in supply amount of the current, and variations in central wavelength and frequency according to the variation in supply amount of the current is referred to as a chirp. Light which periodically changes may be supplied to an OPA using a chirp phenomenon, and thus input light for an FMCW operation may be supplied to the transmission OPA device 120.

The transmission OPA device 120 is a non-mechanical (electronic) beam scanning device for transmitting a beam to a two-dimensional (2D) space.

When laser light emitted from the LD travels to the transmission OPA device 120 through the variable optical attenuator 152, the laser light is divided into several branches in the transmission OPA device 120 through waveguides, phases of the divided laser lights are arranged, and then the divided laser lights are combined again. Thus, a beam according to the phases controlled in an output part of the transmission OPA element 120 is transmitted to the atmosphere with directionality and reaches an object, and then the reflected light is received by the reception OPA device 130 again.

The transmission OPA device 120 may be configured such that a plurality of transmission OPA devices 120 are configured in parallel to form a transmission OPA device group (Tx OPAs). That is, although eight waveguides of one transmission OPA device 120 have been shown in the example, OPAs with different vertical radiation angles may be disposed in multiple stages (Tx OPAs) for wide vertical beam-steering. In order to sequentially operate the OPAs, 1×n switches 153 (n is a natural number of two or more) may be arranged at a rear stage of the variable optical attenuator 152.

The transmission OPA device 120 includes power splitters 121, a phase shifter 122 (1×N-array), and a radiator 123 (1×N-array).

Light incident from a single light source is divided into N channels (N is a natural number of two or more) through power splitters 121. In this case, the power splitters 121 are not limited to multimode interference (MMI) power splitters and may be comprised of power splitters having various structures, such as a Y-branch coupler, a directional coupler, and a star coupler.

Further, as shown in the drawing, a structure in which 1×2 power splitters are disposed in multiple stages, or a structure in which one device may be used to branch off into N channels.

As described above, the phase shifter 122 connected to each channel after branching off into to the N channel may also employing an electro-optic method (e.g., a p-i-n or p-n structure) or a thermo-optic method (e.g., a p-i-n or external metal heater structure), and the phase of the light incident to each channel is controlled in order to adjust directionality of the beam emitted from the radiator 123 into the atmosphere (air).

That is, in order to supply light waves having phase differences at equal intervals to each radiator 123, the phase shifter 122 serves to control the phases of the light waves.

Then, the phase-controlled channels are collected to the radiator 123, and the light waves are radiated into the free space and the atmosphere (air) in a state of having specific directivity (angle) according to a wavelength of the input light, a shape of the phase controlled from the phase shifter 122, and a shape and an arrangement of the radiator 123.

To this end, the radiator 123 may be implemented in a lattice structure, a mirror structure, a nano-metal thin film structure, or the like. For example, a lattice structure formed at an end of the optical waveguide may radiate the light waves into a space above a lattice due to scattering of the light waves colliding with the lattice.

Therefore, since the radiator 123 is formed and disposed in a 1×N radiator array, the phase of the light wave input into the 1×N radiator array is set to a specific phase for each radiator so that a phase matching beam having a narrow divergence angle may be formed in a space in a specific direction due to interference between the radiated light waves.

In such an array, scanning in a latitude direction, which is a longitudinal direction, is not performed by only a change in phase. To this end, as shown in the drawing, a plurality of 1×N arrays are arranged in the longitudinal direction so that a beam may be radiated two-dimensionally. Alternatively, the scanning in the latitude direction may be implemented by adjusting a wavelength or a refractive index of the radiator 123.

As described above, the reception OPA device 130 is a device which receives the reflected light after being radiated.

Conventionally, a separate photodiode or the like is used as a device for receiving light, but, in the present disclosure, the reception OPA device 130 is manufactured together with the transmission OPA device 120 through a single semiconductor process.

That is, light emitted into the atmosphere (air) through the transmission OPA device 120 in a state of having specific directionality is reflected from an object and then received through the reception OPA device 130.

The reception OPA device 130 is basically configured in the same structure as the transmission OPA device 120. When the light is received by a receiver 133 (1×N array) and phase control of the transmission OPA device 120 and the reception OPA device 130 is performed through the phase shifter 132 in the same manner, only a component of light reflected in the same direction of the light, which is emitted in the specific direction through the transmission OPA device 120 and then reflected from the object to be scattered, may be received through the reception OPA device 130 so that noise may be minimized.

That is, since the phase control of the transmission OPA device 120 and the reception OPA device 130 is performed in the same manner, as in the case of a phased array antenna of the existing LiDAR, signal-to-noise (SNR) may be significantly improved. Thus, the reception OPA device 130 is used so that it is possible to extract a component of reflected light with high SNR without a lens.

After the phase adjustment, the light undergoing amplification by a power combiner 131 travels to the photo detector 142, and reference light branching off from the directional coupler 151 is compared with the light received from the reception OPA device 130 to measure a distance to a reflective object.

A switch 154, which is configured to sequentially operate a plurality of reception OPA devices 130, may be arranged at a rear stage of the power combiner 131.

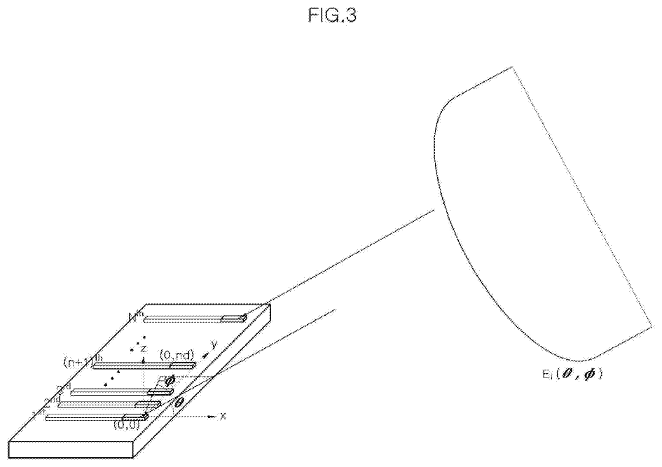

FIG. 3 is a schematic diagram illustrating light received by the reception OPA device 130. Referring to FIG. 3, reception of light reflected from the object will be described in more detail.

As shown in the drawing, in an antenna arrangement structure of the reception OPA device 130, a size of an E-field received by an n^{th} antenna is as follows.

$$E ( n ) = {\int }_{0}^{2 π} {\int }_{0}^{π} G ( θ , Φ ) {e}^{- i \frac{2 π}{λ} Δ l ( n )} d θ d Φ \\ Δ l ( n ) - nd sin θ cos Φ \\ ΔΦ ( n ) = \frac{2 π}{λ} ( nd sin {θ}_{0} cos {Φ}_{0} ) \qquad [ Equation 1 ]$$

The E-field input to each antenna has a path difference of Δl(n) to cause a phase difference. Further, ΔΦ(n) is a phase difference generated by the n^{th} antenna of the reception OPA device 130 targeting predetermined angles θ0 and Φ0.

Therefore, the total E-field received from the reception OPA device 130 targeting the predetermined angles θ0 and Φ0 is expressed as Equation 2 below, and interference correction occurred due to a phase difference of each antenna is expressed as Equation 3.

$$\begin{matrix}{E}_{R} ( {θ}_{0} , {Φ}_{0} ) = {\sum }_{n = 0}^{N - 1} E ( n ) {e}^{i} ΔΦ ( n ) = {\sum }_{n = o}^{N - 1} {\int }_{0}^{2 π} {\int }_{0}^{π} G ( θ , Φ ) {e}^{i ( ΔΦ ( n ) - \frac{2 π}{λ} Δ l ( n ) )} d θd Φ - {\int }_{0}^{2 π} {\int }_{0}^{π} G ( θ , Φ P ( θ , Φ , {θ}_{0} , {Φ}_{0 ) d} θ d Φ & [ Equation 2 ] \\ P ( θ , Φ , {θ}_{0} , {Φ}_{0} ) = {\sum }_{n = 0}^{N - 1} {e}^{- i \frac{2 π d}{λ} [ n ( sin θ cos Φ - sin {θ}_{0} cos {Φ}_{0} ) ]} & [ Equation 3 ]\end{matrix}$$

The light from the object is reflected in a hemispherical shape. However, since the distance to the object is very long when compared to a size of a window of the reception OPA device 130, the incident light becomes parallel light in which a direction component is constant.

Further, referencing to the above equations, only a beam having the same phase (direction) as the tuned and radiated beam is received so that the photo detector 142 compares the beams having the same phase to measure a distance to the reflective object.

Conceptually, the reception OPA device 130 increases reception performance in a direction of reducing a noise level by filtering all light except for light incident at a predetermined angle.

Next, the mixer 141 receives the reference light input thereto as a local oscillator from the integrated hybrid LD 110 through the directional coupler 151 and the light transmitted from the transmission OPA device 120 and input by the reception OPA device 130 to mix and beat the reference light and the input light through a 90-degree hybrid coupler.

When two types of lights are incident on two input ports of the mixer 141, lights having 180-degree phase difference light are output to output ports, and a frequency difference between the light received by the reception OPA device 130 through the photo detector 142 and the light of the local oscillator may be extracted (a down-conversion function). Since laser frequency modulation is performed at a constant rate over time using a laser chirp, distance information to an object, which is to be measured, may be obtained using the extracted frequency difference between the lights. Further, as described above, the down-conversion is possible and, simultaneously, a conversion gain by as much as a ratio between the reference light and the received light may be obtained so that a great advantage may be achieved in terms of light reception.

As described above, an optical signal undergoing the down-conversion and obtaining the conversion gain is detected by the photo detector 142.

The photo detector 142 (balanced PAT-PD) is a device having a basic function of converting an optical signal into an electrical signal and detecting the electrical signal. PAT-PD does not employ a heterojunction material such as Ge or a group III-V material, employs all silicon materials to serve as a traveling-waveguide type PD, and a balanced PAT-PD is configured using a corresponding PAT-PD.

Conventionally, since the existing LiDAR collects reflected light through a lens, a surface reception type avalanche photodiode (APD) or a single photon detector is generally used, whereas, in the present disclosure, since the light received by the reception OPA device 130 is collected in a single waveguide, it is difficult to combine with a surface reception photo detector (PD) so that it is advantageous to connect to the traveling-waveguide type PD rather than a PD of a corresponding structure.

For example, in the case of a traveling waveguide PD having a silicon p-n junction structure, since silicon is inherently transparent to light having a wavelength of 1.3 μm, absorption of a photon hardly occurs. Nevertheless, a photocurrent may be obtained through photon assisted tunneling and impact ionization by applying a reverse bias which is strong to a p-n junction. Therefore, when the above structure is used, there is an advantage of forming the PD with all silicon materials without difficultly forming a heterojunction PD with Ge or a group III-V material so that, in the present disclosure, a method of detecting reflected light by connecting the reception OPA device 130 to the photo detector 142 is applied.

As described above, according to one exemplary embodiment of the present disclosure, the transmission OPA device 120, the reception OPA device 130, the mixer 141, and the photo detector 142 may be embodied as a single silicon-based semiconductor module and configured as a circuit so that it is possible to form a LiDAR system for autonomous vehicles to be very small and robust.

In accordance with the present disclosure, a receiver is included in an entirety of an optical phased array (OPA) circuit, whereas, in a related art, a photodiode (PD) which is a separate device receives a reflected beam after being radiated. That is, the receiver receives the reflected beam as an Rx OPA having the same structure as a Tx OPA.

Therefore, since the Rx OPA is used instead of the PD which receives light in all directions, it is possible to receive reflected light with directionality so that interference due to infrared rays emitted from solar light or infrared rays emitted from an adjacent LiDAR system can be removed.

Further, since a frequency modulation method using current injection of a semiconductor LD is employed, a bulky external light source is excluded and the semiconductor LD is hybrid integrated with the transmission and reception OPAs so that a LiDAR system for an autonomous vehicle can be formed to be very small.

While the present disclosure has been described with reference to the accompanying drawings, it will be apparent to those skilled in the art that various changes and modifications may be made without departing from the spirit and scope of the present disclosure as defined in the following claims. Accordingly, it should be noted that such alternations or modifications fall within the claims of the present disclosure, and the scope of the present disclosure should be construed on the basis of the appended claims.

What is claimed is:

1. A laser transmitting and receiving module for a light detection and ranging (LiDAR), comprising:
a laser light source;
a transmission optical phased array (OPA) device configured to emit laser light from the laser light source into a two-dimensional (2D) area;
a reception OPA device configured to receive reflected laser light after being emitted by the transmission OPA device;
a mixer configured to mix the laser light with the reflected laser light received by the reception OPA device; and
a photo detector configured to detect an optical signal mixed by the mixer.

2. The laser transmitting and receiving module of claim 1, further comprising:
a variable optical attenuator arranged at a front stage of the transmission OPA device and configured to equally adjust optical power; and
a directional coupler arranged at a front stage of the variable optical attenuator and configured to allow a portion of the emitted laser light to branch off to the mixer.

3. The laser transmitting and receiving module of claim 2, wherein:
the directional coupler allows the portion of the emitted laser light traveling to the variable optical attenuator to branch off to the mixer as reference light,
the mixer mixes the reference light with the reflected laser light, and
the photo detector detects an optical signal undergoing down-conversion and obtaining a conversion gain.

4. The laser transmitting and receiving module of claim 3, wherein the directional coupler, the photo detector, and the mixer serve as a reception module required in a frequency modulated continuous wave (FMCW) operating method.

5. The laser transmitting and receiving module of claim 4, wherein the photo detector includes a traveling-waveguide type photo detector (PD) having a silicon p-n junction structure.

6. The laser transmitting and receiving module of claim 1, wherein the transmission OPA device includes:
a power splitter configured to allow the emitted laser light to branch off into N channels, where ‘N’ is a natural number of two or more;
a phase shifter configured to control each of phases of the laser light incident on the N channels; and
a radiator configured to radiate the laser light phase-controlled by the phase shifter to a free space with a specific directionality.

7. The laser transmitting and receiving module of claim 6, wherein the power splitter includes a multimode interference (MMI) power splitter.

8. The laser transmitting and receiving module of claim 6, wherein the phase shifter controls the phase of the laser light reaching the radiator to control the laser light radiated through the radiator toward a specific direction.

9. The laser transmitting and receiving module of claim 8, wherein the phase shifter controls the phase of the laser light by an electro-optic method or a thermo-optic method, the electro-optic method utilizes a p-i-n or p-n structure, and the thermo-optic method utilizes a p-i-n or external metal heater structure.

10. The laser transmitting and receiving module of claim 6, wherein the radiator is formed to be disposed as a 1×N radiator array.

11. The laser transmitting and receiving module of claim 10, wherein each radiator of the 1×N radiator array is formed in any one structure among a lattice structure, a mirror structure, or a nano-metal thin film structure.

12. The laser transmitting and receiving module of claim 10, wherein a plurality of radiators are formed to be disposed as a 1×N radiator array in a longitudinal direction.

13. The laser transmitting and receiving module of claim 6, wherein:
the transmission OPA device is disposed as a plurality of transmission OPA devices in parallel, and
a switch configured to sequentially operate the plurality of transmission OPA devices is arranged at a rear stage of the variable optical attenuator.

14. The laser transmitting and receiving module of claim 6, wherein the reception OPA device includes:
a receiver configured to receive the reflected laser light through the N channels;
a phase shifter configured to control each of phases of the reflected laser light branching off in the N channels; and
a power combiner configured to combine the reflected laser light which is phase-controlled and received through the N channels.

15. The laser transmitting and receiving module of claim 14, wherein the phase shifter of the reception OPA device controls phases of the reflected laser light received through the N channels in the same manner as in a phase control by the transmission OPA device.

16. The laser transmitting and receiving module of claim 14, wherein:
the reception OPA device is disposed as a plurality of reception OPA devices in parallel, and
a switch configured to sequentially operate the plurality of reception OPA devices is arranged at a rear stage of the power combiner.

17. A laser transmitting and receiving module for a light detection and ranging (LiDAR), comprising a transmission optical phased array (OPA) device configured to transmit laser light from a laser light source to a two-dimensional (2D) area and a reception OPA device configured to receive reflected laser light after being transmitted by the transmission OPA device, wherein the transmission OPA device and the reception OPA device are modularized as a single silicon-based semiconductor device.

18. The laser transmitting and receiving module of claim 17, wherein the transmission OPA device includes:
a power splitter configured to allow the transmitted laser light to branch off into N channels, where ‘N’ is a natural number of two or more;
a phase shifter configured to control each of phases of the laser light incident on the N channels; and
a radiator configured to radiate the laser light phase-controlled by the phase shifter with a specific directionality.

19. The laser transmitting and receiving module of claim 18, wherein the reception OPA device includes:
a receiver configured to receive the reflected laser light through the N channels;
a phase shifter configured to control each of phases of the reflected laser light received through the N channels; and
a power combiner configured to combine the reflected laser light which is phase-controlled and received through the N channels.

20. The laser transmitting and receiving module of claim 19, further comprising:
a photo detector configured to compare the transmitted laser light with the reflected laser light received by the reception OPA device; and
a mixer arranged at a front stage of the photo detector and configured to receive the reference light and the reflected laser light and to convert and mix a phase.
